(19) United States
(12) Patent Application Publication
(10) Pub. No.: US 2024/0168806 A1
(43) Pub. Date: May 23, 2024

(54) SHARING OF AVAILABLE RESOURCES OF AUTONOMOUS VEHICLES

(71) Applicant: INTERNATIONAL BUSINESS MACHINES CORPORATION, ARMONK, NY (US)

(72) Inventors: Adinarayana Haridas, Hyderabad (IN); Sarbajit K. Rakshit, Kolkata (IN); Abhishek Jain, Baraut (IN); Harald Seipp, Mainz (DE); Frank Kraemer, Bodenheim (DE)

(21) Appl. No.: 17/990,652

(22) Filed: Nov. 18, 2022

(51) Int. Cl. G06F 9/50

(52) U.S. Cl. CPC G06F 9/5027

(57) ABSTRACT

A computer-implemented method for sharing of non-critical resources of autonomous vehicles. The method identifies available non-critical resources of autonomous vehicles by a communicative connection. The method receives a request from a computing device of a requesting user for travel in an autonomous vehicle and for use of the available non-critical resources, wherein the request is received. The method determines the autonomous vehicles having the non-critical resources available to fulfill the request and presents to the requesting user information regarding the available resources. The method receives a selection of a set of the available non-critical resources and generates a resource stack configuration from the selected set of available non-critical resources, and the method grants access to the generated resource stack configuration.

### BACKGROUND

The present invention relates to sharing available resources of autonomous vehicles and, more specifically, to determining the available non-critical resources within a plurality of autonomous vehicles operating within an autonomous vehicle transport management system and providing passengers of the autonomous vehicles access to use the available resources.

An autonomous vehicle transport system provides tracking and flow management of autonomous vehicles providing public transportation within subsections of a “smart city” enabled by wireless data communication with the autonomous vehicles. The autonomous vehicle transport system (AVTS) communicates respectively with a plurality of autonomous vehicles (AVs). Communication of AVs includes two-way communication with traffic management infrastructure and communication between vehicles.

Autonomous vehicles may require significant amounts or capacities of resources to receive, analyze, and rapidly respond to sensor and communication input. Effective responses may require minimal latency in the processing of data input during mobile operation of an autonomous vehicle (AV). On-board resources may include one or more central processing units, memory, storage, and various software applications and platforms.

### SUMMARY

According to one embodiment of the present invention, a computer-implemented method provides for provisioning available non-critical resources of autonomous vehicles.

Aspects of the invention disclose a computer implemented method, system, and computer readable media associated with providing non-critical resources for requested activity of a riding passenger of an autonomous vehicle, by one or more processors. Aspects of the invention disclose one or more processors identifying which vehicles of the one or more autonomous vehicles operating within an autonomous vehicle transport management system (AVTMS) include available portions of non-critical resources of the one or more autonomous vehicles. Aspects of the invention disclose the one or more processors receiving a request from a computing device of a user for travel in an autonomous vehicle operating within the AVTMS in which the request includes the use of available non-critical resources as a resource stack configuration. Aspects of the invention disclose the one or more processors determining one or more autonomous vehicles having the non-critical resources available to fulfill the request. Aspects of the invention disclose the one or more processors presenting to the requestor information regarding the non-critical resources available to fulfill the request, receiving from the requestor a selection of a set of the available resources, generating a resource stack configuration based on the selected available non-critical resources, and granting access to the generated resource stack configuration based on the selected set of available, non-critical resources requested from the computing device of the requesting user.

### BRIEF DESCRIPTION OF THE DRAWINGS

FIG. 1 provides a schematic representation of a computing environment, in accordance with an embodiment of the present invention.

FIG. 2 provides a flowchart of operational steps for provisioning available, non-critical computing resources of autonomous vehicles, in accordance with an embodiment of the present invention.

FIG. 3 depicts a cloud computing environment, according to an embodiment of the invention.

FIG. 4 depicts abstraction model layers, according to an embodiment of the invention.

### DETAILED DESCRIPTION

Some embodiments will be described in more detail with reference to the accompanying drawings, however, embodiments of the present disclosure can be implemented in various manners, and thus should not be construed to be limited to the embodiments disclosed herein.

An autonomous vehicle (AV) may experience latency in communicating with centralized cloud-based control communications as well as latency in response to edge-processing of sensor data during mobile operation. Response latency may result in failure to avoid a collision or perform timely maneuvers that may result in accidents and even tragedy. Embodiments recognize latency consequences can be reduced and possibly minimized by including onboard processing of sensor and service-based data during mobile operation of an AV. To perform latency-reduced processing onboard an AV requires abundant hardware and software resources that include central processing units (CPUs), which may include multiple cores, memory, storage, multiple applications, network connections, and application platforms.

Embodiments of the present invention recognize that the operation of an AV relies on certain amounts of critical computer-based resources, management of travel with other vehicles, and the safety of passengers, however, conditions encountered by the AV may vary, which may increase or reduce the amount of critical resources required for the mobile operation of the AV at any point in time. Embodiments of the present invention determine the non-critical resources available during the travel operation of one or more autonomous vehicles (AVs) and using application programming interfaces, enable users requesting transportation on an AV to also request the use of available non-critical resources to perform work, learning, or other activity by connecting the user's computing device to requested and approved, available resources associated with an AV that may be one of a plurality of AVs providing transportation to requesting users within an AV enabled area, such as an area within a smart city. A smart city includes a framework that uses digital and communication technologies applied to infrastructure to develop, promote, and manage sustainable systems addressing urbanization challenges.

Aspects of the present invention relate generally to utilizing non-critical available resources onboard autonomous vehicles and, more particularly, to providing resource-requesting passengers of autonomous vehicles access to select resources, such as a software stack and supporting hardware, referred to collectively as a resource stack or resource stack configuration, during travel on an autonomous vehicle. Access to requested resources enables autonomous vehicle passengers to perform work, engage in learning activities, engage in streaming delivery of content, or perform other activities using their personal computing device connected to available, non-critical AV resources during travel. An aspect of the invention identifies available, non-critical resources of the autonomous vehicles operating with connection to an autonomous vehicle transport management system (AVTMS), determining the type, amount, and projected timeframe of availability of the resources. Availability of non-critical resources can be determined by sensor monitoring of AV resources over historical travel routes and timeframes that indicate the resource demands.

An aspect of the invention includes receiving resource utilization data from AV sensors monitoring the status of resources and including analysis of anticipated traffic and travel conditions projecting the availability level of resources for a duration of user travel within the AV, based on historical travel and timeframe data.

Disclosed embodiments include methods that establish communication with AVs via application programming interfaces (APIs) and determine available non-critical resources of respective AVs. For example, sensors of a particular AV may communicate with methods through an API, and indicate a CPU utilization below 15%, with memory utilization at 20% and storage at 10%. Methods may also determine the applications available and in use for the particular AV. Embodiments may determine resources that support advanced features and amenities of the vehicle, such as entertainment systems, which remain disabled or not currently and foreseeably in use. Embodiments include the resources supporting amenities and advanced features of the vehicle in determining the available non-critical resources. Methods perform the determination of available non-critical resources across multiple AVs, such as a fleet of AVs used for public transportation within sections of a city enabled with digital and communication technologies and infrastructure enabling autonomous vehicle travel.

Methods may determine a critical amount of resources required for AV operation, and a buffer range of resources to withhold for managing an immediate dynamic increase in resource requirement by the particular AV and designate remaining resource amounts as available, non-critical resources. The determination of available non-critical resources may include an assessment of the current position, travel route, traffic congestion level, weather conditions, and other considerations in determining whether certain resources and amounts of resources can be included as being available for use by passengers requesting access to resources during autonomous vehicle operation. Methods associate the identified available non-critical resources with their respective AVs, however, an aspect of the present invention includes provisioning available non-critical resources of one AV to a passenger of another nearby AV, based on the request made by the passenger and the availability of resources at the time of the request. For example, two AVs may be traveling to the same destination within a similar timeframe and may remain within a designated distance range for the duration of travel. Methods may provision a request from a passenger of the first vehicle to the resources of the second vehicle that has greater availability of resources and a software stack selection matching the passenger's request.

Another aspect of the invention includes receiving a combination request for AV transportation and the use of available AV non-critical resources during the period of transportation. In an embodiment of the present invention, an application (app) operating on a requesting user's computing device provides an input channel for a request for transportation on an autonomous vehicle to a designated destination. The application enables the user to request a ride and request the use of available resources from an AV providing transportation to the designated destination. The requesting user receives from the app a presentation of available resources, which may include available software stacks, hardware resources (i.e., memory/storage), and, in some instances, network connections. The combination of software and hardware configurations may be presented as resource configuration stacks. In some embodiments, methods present a listing of available resources for respective AVs providing transportation to a user-designated destination or travel route, whereas in other embodiments, available resources may be presented to the user as a set of resources configured as a resource stack

For example, for developers interested in using the transportation time to perform work, the app may present an available stack such as a LAMP stack (Linux, Apache, MySQL, and PHP), MEAN stack (MongoDB, Express.js, AngularJS, and Node.js), or the MERN stack (ReactJSX replaces Angular of MEAN stack), MEVN stack (Vue.js replaces Angular of the MEAN stack), and identify their respective corresponding AV.

In some embodiments, the app may enable the requesting user to designate the resources being requested, which may range from a browser connection to the Internet for streaming video or gaming, to a customized developer software stack with database connections. Methods determine whether the resource request can be met by the identified available resources of AVs providing transportation to the requested destination. In some embodiments, methods present resource configurations available and the identification of the AV(s) providing the resources, to the requesting user for selection. In some embodiments, methods may indicate in the display of the app to the requesting user the estimated duration of resource availability during the requested transportation travel. In some embodiments, methods may estimate the time required to configure components of requested resource stacks indicating how quickly the requested resources of identified AVs can be provided.

An aspect of the invention includes changing the provision of requested and available resources from a first AV to a nearby second AV due to the resource configuration stack of the first AV experiencing slowed or delayed performance or other service delivery issues. In some embodiments, methods provide notification to the requesting user through the app on the requesting user's computing device acknowledging the issue with resources of the first AV and indicate the source of resources being switched to the second AV. Aspects of the invention also include providing an indicator on the computing device app of the requesting user identifying the passenger (i.e., requesting user), confirming the accepted request, and identifying the AV providing the particular resource use request.

Another aspect of the invention includes recognition of a change in the availability of resources and providing notification to the requesting user indicating the change in resource availability. In some embodiments, the change in availability of resources may include additional available resources or an extension of the time of availability of the resources, which passengers of a particular AV may utilize. In other embodiments, the change in availability of resources may include pending reduction or loss of available resources, which provides notice to resource-using passengers that may need to take action to save work or take other actions.

An aspect of the invention includes establishing a token in advance of receiving a user request that corresponds to two or more AVs whose planned travel routes have common destinations. The tokens establish a kind of reservation of resources among two or more AVs that have travel proximities that enable sharing of available non-critical resources between or among AVs. The tokens enable the provision of resource stack configurations that may not be fully met with only the available non-critical resources of an individual AV.

Another aspect of the invention includes predicting upcoming requests for resource configurations based on a particular area within the operational range of an autonomous vehicle transport system (AVTS) servicing a smart city, for example. Embodiments predict requests for resource configurations based on machine learning techniques trained on historical request data augmented with location, and timeframe (i.e., time of year, day of the week, time of day, etc.).

As an overview, aspects of the invention disclose a modification to an autonomous vehicle transport system (AVTS) framework enabling the identification of available non-critical resources of connected autonomous vehicles. Methods provision runtime resources (i.e., software stack, applications, supporting resources) to passengers of the autonomous vehicles that have requested the use of available resources during autonomous vehicle transportation. Methods receive requests for resources and present a listing of available resources on a requesting user's computing device via an application operating in conjunction with the methods. Methods receive the requesting user's selection of available resources and grant the requesting user access to the available resources via the requesting user's computing device. In an embodiment of the present invention, methods provide an estimated timeframe of the available resources and provide notification of either increased availability of resources or pending decrease of available resources to the requesting user via the user's computing device display. In some embodiments, the requesting user receives an indication on the display of their computing device of the identified AVs that have the requested resources and travel route to the requested travel destination. In some embodiments, methods pool the available resources of two or more AVs in nearby locations and common travel destinations to fulfill resource requests from user passengers. Methods terminate access to the autonomous vehicle's available resources upon arrival at the requesting user's destination or by user termination prior to arriving at the user's destination.

The solution and improvements provided by the method are not abstract and specifically involve non-critical computing resources associated with autonomous vehicles that can be alternatively utilized by passengers of the autonomous vehicles as available, and cannot be otherwise performed as a mental process performed by a human due to reliance on AV sensor data, resource request application, detection of resource configurations available within respective AVs and dynamic nature of requests, AV destinations, and variable operational requirements of the AV during travel. Further, the receipt and compilation of both dynamic and static sources of input data and resource requests cannot be reasonably received and processed by the mental act of a human.

In an embodiment, one or more components of the system can employ hardware and/or software to solve highly technical problems (e.g., applying methods to determine available non-critical resources within a plurality of autonomous vehicles and granting access to requested available resources from requesting users as passengers of the autonomous vehicles). The practice of the methods provides improvement to an autonomous vehicle environment, providing practical application of available resources to passengers of the respective autonomous vehicles, making productive use or providing requested service from otherwise unused resources, and essentially improving the function and value of autonomous vehicle travel within an area managed by an AVTS.

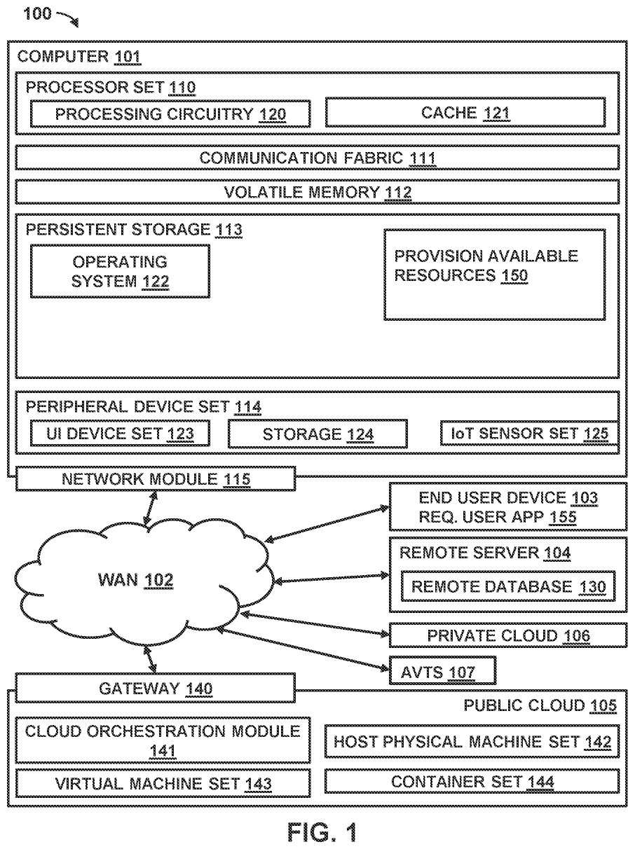

FIG. 1 provides a schematic illustration of exemplary network resources associated with practicing the disclosed inventions. The inventions may be practiced by the disclosed processors performing an instruction stream. As shown in FIG. 1, computing environment 100 contains an example of an environment for the execution of at least some of the computer code involved in performing the inventive methods, such as the method of provisioning available resources in block 150, retained in persistent storage 113. In addition to block 150, computing environment 100 includes, for example, computer 101, wide area network (WAN) 102, end-user device (EUD) 103, which includes requesting user app 155, remote server 104, public cloud 105, private cloud 106, and network connection to autonomous vehicle transport system (AVTS) 107. In this embodiment, computer 101 includes processor set 110 (including processing circuitry 120 and cache 121), communication fabric 111, volatile memory 112, persistent storage 113 (including an operating system 122 and a safety level scores program of block 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or another wearable computer, mainframe computer, quantum computer, or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation on computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct the performance of the inventive methods. In computing environment 100, at least some of the instructions for performing the inventive methods may be stored as a provisioning available resources program in block 150, in persistent storage 113.

COMMUNICATION FABRIC 111 includes the signal conduction paths that allow the various components of computer 101 to communicate with each other. Typically, this fabric includes switches and electrically conductive paths, such as the switches and electrically conductive paths that make up busses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things (IoT) applications. For example, one sensor may be a thermometer and another sensor may be a motion detector. In an exemplary embodiment, IoT sensor set 125 includes static and dynamic IoT devices providing input data to the GSS model along with historical and online social media-based data.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers. In an exemplary embodiment, WAN 102 enables access to and receipt of data from historical data of safety-related incidents of travel parking spots, which may be stored in a remote database 130. WAN 102 also enables access to and receipt of data from social media sources, blockchain data, and ad-hoc crowd-sourced feedback data, which may be accessed via gateway 140 to public cloud 105, for example.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on. In some embodiments, EUD 103 receives and displays a listing of safety level scores for travel parking spots in the geospatial area of the user's vehicle and one or more recommendations.

REQUESTING USER APP 155 is an application operating on a requesting user's computing device and working in conjunction with methods for provisioning available resources of autonomous vehicles during travel by the user, in block 150. Requesting user app 115 enables users of autonomous vehicle transportation to request transportation and, in addition, request the use of available non-critical resources. In some embodiments, requesting user app 115 presents available resources on a display of EDU 103 for selection. The listing of available resources may take the form of a configured software stack (e.g., LAMP), may offer a selection of components for a user to configure a custom software stack from a listing of available resources, or may offer input of desired resource components by the user. In other embodiments, the user may request the use of resources by input of a functional request rather than selection or input of specific software stack or stack components, such as requesting Internet access, use of a particular application, requesting a game to play, or requesting display of streaming content. Requesting user app 155 also displays confirmation of users' requests and in some embodiments, may indicate a confirmation on the user's computing device display, associating the user with resources of a particular identified AV.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs, and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

AUTONOMOUS VEHICLE TRANSPORT SYSTEM (AVTS) 107 is an intelligent transport management system for autonomous vehicles operating within a designated area and includes a framework to identify and locate autonomous vehicles and provide smooth flow of public and private transportation. In some embodiments, AVTS 107 operates within a “smart city” enabled with networking resources for communication between vehicles and traffic infrastructure management devices. In some embodiments, methods operating within an AVTS framework receive input indicating the non-critical available resources of respective autonomous vehicles within the AVTS operational area. Methods determine and configure software stack resources from the determined available resources and associate the available resources with identified autonomous vehicles. In some embodiments AVTS 107 manages a fleet of public transportation autonomous vehicles, providing transportation and access to available non-critical resources as requested by user passengers. In other embodiments, AVTS 107 may include some management and available resource determination from both public and private autonomous vehicles and provides access to available non-critical resources including providing access to resources from a second nearby vehicle to a requesting user as a passenger in a nearby first vehicle.

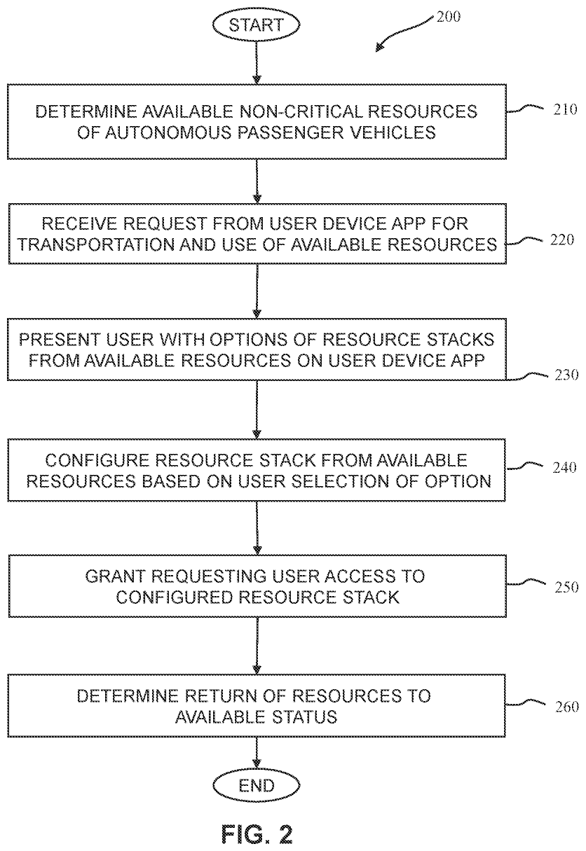

FIG. 2 provides a flowchart 200, illustrating exemplary activities associated with the practice of the disclosure. Subsequent to program initiation, at step 210, the method determines the available non-critical resources of autonomous passenger vehicles. For low latency response to navigation, objects, and situations encountered during travel, embodiments of the present invention recognize that considerable amounts of computing resources are included aboard autonomous vehicles. The method communicates with autonomous vehicles via an AVTS operating within a defined area and enhanced with an autonomous vehicle resource stack API management system to identify non-critical available resources of the autonomous vehicles and enable sharing of the available resources. The method gathers available resource data from all the connected (and participating) autonomous vehicles within the AVTS operational area. Non-critical resources identified include CPU, memory, storage, and network access available during low-resource demand operation. The method determines the autonomous vehicle corresponding to a set of available non-critical resources and consolidates the available non-critical resources, identifying software stacks and functional activities supported by the consolidated available resources.

For example, the AVTS includes application programming interfaces (APIs) to receive information indicating available non-critical resources from autonomous vehicles operating within the management area of the AVTS, such as within areas of a smart city. The method receives the available resource information and identifies the autonomous vehicle corresponding to the available resources. The method consolidates the available resources and may identify components that comprise common or known software stacks such as LAMP.

At step 220, the method receives a request from a user device application (app) for transportation and use of available resources. Embodiments recognize that some users request transportation alone, whereas other requests will include transportation to a designated destination or travel path and include a request for access to available resources of an autonomous vehicle during the duration of travel for the requesting user. Upon receipt of a user request, the method discerns whether the request includes the use of available resources. In some embodiments, the received request includes a general request for types and levels of resources available. In other embodiments, the user request includes resources to enable the use of a particular application or to perform a functional activity, such as an Internet search or access and streaming of content to a user's computing device.

For example, a requesting user submits a request for autonomous vehicle transportation to a destination along a travel route within a smart city by using an application (app) operating on the computing device of the requesting user. The user also requests access to available resources by selecting a resource request image on the app in communication with the method.

At step 230, after determining a received request includes transportation and use of available resources, the method determines the resources requested by the user/passenger. In some embodiments, the method presents the requesting user with options of resource stacks available from autonomous vehicles providing transportation to a destination or travel path requested. The method presents the resource stack options on the computing device display of the user and enables the selection of a resource stack by the user. In other embodiments, the method queries the requesting user to input the resources they wish to access during transportation. In the embodiment, the method searches the list of identified available resources and determines whether a customized stack configuration can be assembled. In yet other embodiments, the method queries the user to identify the functional activity to be performed during transportation requiring available resources, such as Internet access, streaming content, game playing, video conference, or other functional activity.

For example, subsequent to determining the request for autonomous vehicle transportation received from the user includes a request for use of available resources, the method determines the resources requested by the user by presenting a listing of resource stacks available for use on the app operating on the user's computing device, such as software stacks of LAMP, MEAN, MERN, or MEVN. In another example, the method receives input from the requesting user for a customized resource stack. In yet another example, the method receives a request for non-specific resources to perform a functional activity, such as playing a game, or streaming music or video content.

At step 240, the method configures a resource stack from available resources based on the option selection received from the user. In an embodiment in which the requesting user selects a resource stack displayed on the app operating on the user's computing device, the method identifies the available components of the resource stack and the corresponding autonomous vehicle providing the resource stack and designates the resources as assigned to the user's request, removing the resources from an “available” status. In another embodiment, the method configures a customized resource stack to fulfill the request of the user from the identified available resources of autonomous vehicles.

In some embodiments, the resource stack includes resources from a single autonomous vehicle that provides transportation to a requested destination or along a designated travel route. In other embodiments, the configuration of the resource stack includes accessing resources from two or more autonomous vehicles that provide transportation to a common destination or travel route while maintaining in a nearby location such that the requested resource stack configuration includes some resources of respective autonomous vehicles. In yet other embodiments, the received request from resources designates an activity to be performed by the requesting user during transportation. The method identifies whether requested activity can be enabled by the available resources, such as streaming content, playing an online game, performing searches on an Internet connection, and the like. The method matches available resources to the request for resources to fulfill the user's request. For the case in which the available resources do not match the requested resources, the method provides a message indicating a lack of availability and may provide a suggested alternative of resource stack configuration or may inquire as to whether the user has an alternative request.

For example, the method determines the user-requested (transportation on a designated travel route, and the resource stack including Linux, Apache, MySQL, and PHP software (LAMP), and matches the autonomous vehicle corresponding to the user's travel route and having the available LAMP resources to the particular user's request. The method matches the resource request to the identified available resources associated with respective autonomous vehicles and determines whether the transport and resource request can be met and, if so, which autonomous vehicles can provide both transport and fulfillment of the resource request. In another example, the method receives a resource request enabling the user to access and play a particular game during the travel time to the user's destination.

At step 250, having determined availability of the requested resources, the method grants access of the configured resource stack to the requestion user. Methods indicate to the requesting user the availability of the requested resource stack or functional activity resources and confirm the assignment of the requested resources to the requesting user. In some embodiments, the method provides a confirmation indicator on the app displayed on the requesting user's computing device and indicates the identification of the autonomous vehicle for transportation that provides the requested resources. The method may provide an additional selection for the user if more than one autonomous vehicle can provide the requested resource stack and confirm the grant of resources with the user's selection of an autonomous vehicle.

For example, the method provides a confirmation indicator granting access to the requested resources for the requesting user on the display of the app operating on the computing device of the requesting user. The confirmation of granting access to the requested available resources indicates the user identification and the resources assigned to the user's request, as well as identifying the autonomous vehicle selected by the user.

In some embodiments, the user may receive a notification if the availability of the resources may likely be reduced or become unavailable due to unforeseen resource requirements by the travel operation of the autonomous vehicle. In some embodiments, the notification provided by the method anticipates the reduction or loss of resources providing an opportunity for the user to complete or save activity prior to resource loss. For example, the method may detect an unusual amount of pedestrian traffic in a travel route other than in designated crosswalks and requires additional resources to be applied to vehicle sensors and navigation. The method presents the user with a notification that resources may be reduced or lost due to unforeseen issues and advises the user to prepare for the interruption or loss of resources. In another embodiment, the user may receive a notification indicating the availability of additional resources if the user wishes to increase resource usage during travel.

At step 260, the method returns resources to an available status subsequent to the termination of the user's requested transportation. The method determines the approach of the autonomous vehicle to the requesting user's destination, based on the destination input by the user to the app operating on the computing device of the requesting user and communicating with the method. The method notifies the requesting user that the transportation and use of available resources will be terminated shortly. In some embodiments, the method indicates an estimated time of arrival for the requesting user and for termination of resource stack use. Methods terminate the access to the available resources requested by the user and change the status of the use of the resources granted to the requesting user back to an “available” status in the listing or available resources associated with the particular autonomous vehicle. In some embodiments, where the user has opted in to having a record of resource usages saved, the method logs a record of an identification of the user, the destination traveled, and the requested resources to establish a history for potential repeated requests and to pre-configure resource stacks that match the high frequency of requests.

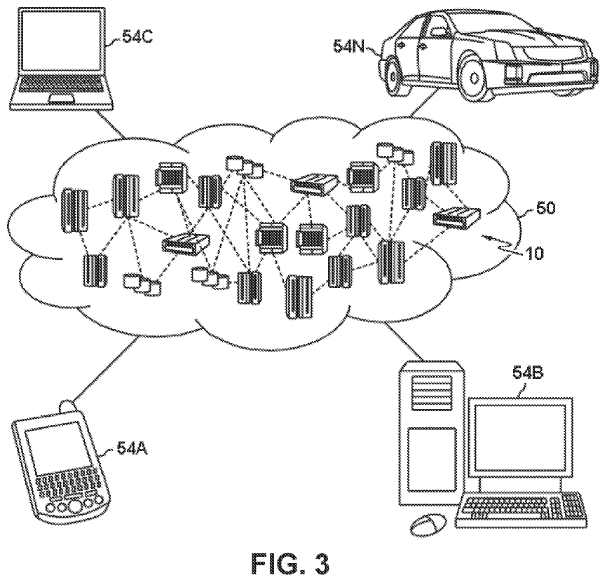

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms, and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

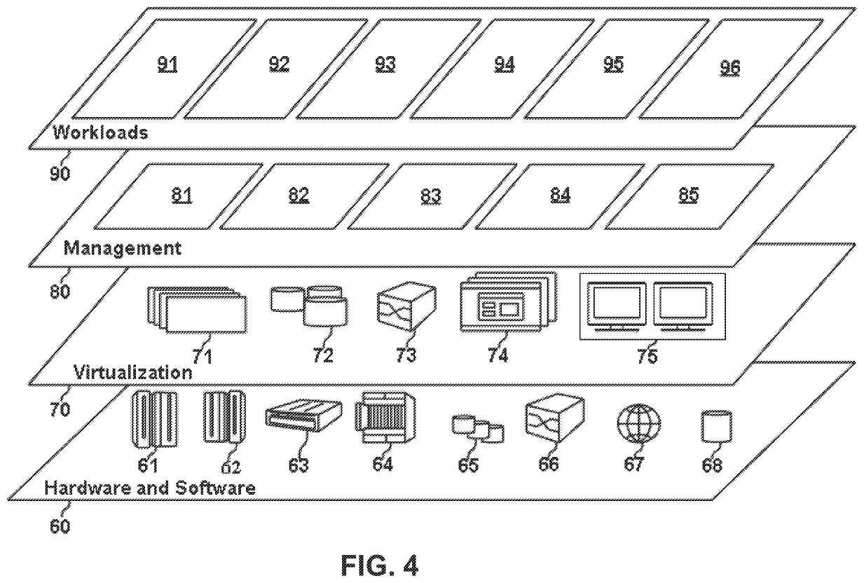

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes: hardware and software components. Examples of hardware components include mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and training data set selection program 175.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer, and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special-purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions collectively stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus, or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for providing non-critical resources for requested activity of a riding passenger of an autonomous vehicle, the method comprising:
identifying, by one or more processors, available non-critical resources of one or more autonomous vehicles by a communicative connection to the one or more autonomous vehicles;
receiving, by the one or more processors, an autonomous vehicle travel request and a request for use of at least some of the available non-critical resources, wherein the request is received from a computing device of a requesting user;
determining, by the one or more processors, the one or more autonomous vehicles having the available non-critical resources to fulfill the request;
presenting to the requesting user, by the one or more processors, information regarding the available non-critical resources matching the request;
receiving from the requesting user, by the one or more processors, a selection of a set of the available non-critical resources;
generating, by the one or more processors, a resource stack configuration including the set of available non-critical resources; and
granting, by the one or more processors, access to the generated resource stack configuration based on the selected set of available, non-critical resources requested from the computing device of the requesting user.

2. The method of claim 1, wherein the available non-critical resources include at least one or more central processing unit (CPU), graphical processing unit (GPU), memory, storage, network access, and software applications comprising the resource stack configuration.

3. The method of claim 1, wherein the selection of a set of the available non-critical resources includes receiving a request from the requesting user for resources to perform an activity while riding on the autonomous vehicle.

4. The method of claim 1, wherein an analysis of a travel route current and historical conditions determines whether the requested available resources remain available for a duration of the travel of the requesting user to a requested destination.

5. The method of claim 1, wherein the available non-critical resources are determined based on dynamically receiving resource usage data from sensors on operating autonomous vehicles operating within an autonomous vehicle transport management system (AVTMS).

6. The method of claim 1, wherein identifying the available non-critical resources include identifying a corresponding autonomous vehicle associated with the respective available non-critical resources.

7. The method of claim 1, wherein the request received from the computing device of the user further comprises:
receiving, by the one or more processors, the request by the requesting user inputting requested available non-critical resources to a communicatively connected application (app) operating on the computing device of the user; and
determining, by the one or more processors, whether the request identifies a particular resource stack configuration or a request for a functional activity.

8. The method of claim 1, wherein a token can be established between two or more autonomous vehicles in advance, such that the two or more autonomous vehicles travel to a common destination at an approximately simultaneous timeframe, and wherein the token reserves portions of the available non-critical resources from the two or more autonomous vehicles to fulfill the request for the use of at least some of the available non-critical resources.

9. A computer program product for providing non-critical resources for requested activity of a riding passenger of an autonomous vehicle, the computer program product comprising:
at least one computer-readable storage medium; and
program instructions stored on the at least one computer-readable storage medium, the program instructions comprising:
program instructions to identify available non-critical resources of one or more autonomous vehicles by a communicative connection to the one or more autonomous vehicles;
program instructions to receive an autonomous vehicle travel request and a request for use of at least some of the available non-critical resources, wherein the request is received from a computing device of a requesting user;
program instructions to determine the one or more autonomous vehicles having the available non-critical resources to fulfill the request;
program instructions to present to the requesting user information regarding the available non-critical resources matching the request;
program instructions to receive from the requesting user, a selection of a set of the available non-critical resources;
program instructions to generate a resource stack configuration including the set of available non-critical resources; and
program instructions to grant access to the generated resource stack configuration based on the selected set of available, non-critical resources requested from the computing device of the requesting user.

10. The computer program product of claim 9, wherein the program instructions to determine the one or more autonomous vehicles having the available non-critical resources to fulfill the request include identifying the autonomous vehicle associated with at least some of the available non-critical resources, which include at least one or more central processing unit (CPU), graphical processing unit (GPU), memory, storage, network access, and software applications comprising the resource stack configuration.

11. The computer program product of claim 9, wherein an analysis of a travel route current and historical conditions determines whether the requested available resources remain available for a duration of the travel of the requesting user to a requested destination.

12. The computer program product of claim 9, wherein the available non-critical resources are determined based on dynamically receiving resource usage data from sensors on operating autonomous vehicles operating within an autonomous vehicle transport management system (AVTMS).

13. The computer program product of claim 9, wherein program instructions to receive the request from the computing device of the user further comprises:
program instructions to receive the request by the requesting user inputting requested available non-critical resources to a communicatively connected application (app) operating on the computing device of the user; and
program instructions to determine whether the request identifies a particular resource stack configuration or a request for a functional activity.

14. The computer program product of claim 9, wherein program instructions for a token between two or more autonomous vehicles can be established in advance, such that the two or more autonomous vehicles travel to a common destination at an approximately simultaneous timeframe, and wherein the token reserves portions of the available non-critical resources from the two or more autonomous vehicles to fulfill the request for the use of at least some of the available non-critical resources.

15. A computer system for providing non-critical resources for requested activity of a riding passenger of an autonomous vehicle, the computer program product comprising:
one or more computer processors;
at least one computer-readable storage medium; and
program instructions stored on the at least one computer-readable storage medium, the program instructions comprising:
program instructions to identify available non-critical resources of one or more autonomous vehicles by a communicative connection to the one or more autonomous vehicles;
program instructions to receive an autonomous vehicle travel request and a request for use of at least some of the available non-critical resources, wherein the request is received from a computing device of a requesting user;
program instructions to determine the one or more autonomous vehicles having the available non-critical resources to fulfill the request;
program instructions to present to the requesting user information regarding the available non-critical resources matching the request;
program instructions to receive from the requesting user, a selection of a set of the available non-critical resources;
program instructions to generate a resource stack configuration including the set of available non-critical resources; and
program instructions to grant access to the generated resource stack configuration based on the selected set of available, non-critical resources requested from the computing device of the requesting user.

16. The computer system of claim 15, wherein the program instructions to determine the one or more autonomous vehicles having the available non-critical resources to fulfill the request include identifying the autonomous vehicle associated with at least some of the available non-critical resources, which include at least one or more central processing unit (CPU), graphical processing unit (GPU), memory, storage, network access, and software applications comprising the resource stack configuration.

17. The computer system of claim 15, wherein an analysis of a travel route current and historical conditions determines whether the requested available resources remain available for a duration of the travel of the requesting user to a requested destination.

18. The computer system of claim 15, wherein the available non-critical resources are determined based on dynamically receiving resource usage data from sensors on operating autonomous vehicles operating within an autonomous vehicle transport management system (AVTMS).

19. The computer system of claim 15, wherein program instructions to receive the request from the computing device of the user further comprises:
program instructions to receive the request by the requesting user inputting requested available non-critical resources to a communicatively connected application (app) operating on the computing device of the user; and
program instructions to determine whether the request identifies a particular resource stack configuration or a request for a functional activity.

20. The computer system of claim 15, wherein program instructions for a token between two or more autonomous vehicles can be established in advance, such that the two or more autonomous vehicles travel to a common destination at an approximately simultaneous timeframe, and wherein the token reserves portions of the available non-critical resources from the two or more autonomous vehicles to fulfill the request for the use of at least some of the available non-critical resources.
